(19) United States
(12) Patent Application Publication
(10) Pub. No.: US 2005/0237562 A1
(43) Pub. Date: Oct. 27, 2005

(54) Method of controlling image forming apparatus to determine printing operation depending on residual developer

(76) Inventor: Jung-il Seo, Yonging-si (KR)

Correspondence Address: STANZIONE & KIM, LLP, 919 18TH STREET, N.W., SUITE 440, WASHINGTON, DC, 20006, US

(21) Appl. No.: 11/092,817

(22) Filed: Mar. 30, 2005

(30) Foreign Application Priority Data
Apr. 22, 2004 (KR) 2004-27970

(51) Int. Cl. G06K 15/00

(52) U.S. Cl. 358/1.14

(57) ABSTRACT

A method of controlling an image forming apparatus to determine a printing operation depending on a residual developer includes receiving printing data from an external device, determining whether an auto storage function is set to store the printing data depending on the residual developer, detecting the residual developer in a developing device, comparing the detected residual developer with a predetermined reference residual amount when it is determined that the auto storage function is set, and storing the received printing data in the storage when it is determined that the detected residual developer is less than the reference residual amount according to the comparison. Accordingly, it is possible to prevent deterioration of a print quality due to a lack of the residual developer.

### CROSS-REFERENCE TO RELATED APPLICATIONS

This application claims the benefit under 35 U.S.C. § 119(a) from Korean Patent Application No. 2004-27970 filed on Apr. 22, 2004, in the Korean Intellectual Property Office, the entire disclosure of which is incorporated herein by reference.

### BACKGROUND OF THE INVENTION

1. Field of the Invention

The present general inventive concept generally relates to a method of controlling a printing operation of an image forming apparatus. More particularly, the present general inventive concept relates to a method of controlling an image forming apparatus, which utilizes toner or ink as a developer, to determine a printing operation of printing data based on a residual developer.

2. Description of the Related Art

A typical image forming apparatus, such as a photocopier, a printer, a multi-function machine, or a facsimile machine, prints on a printing paper printing data input from an external device (for example, a computer or a scanner) using a developer such as toner or ink.

The image forming apparatus includes a residual developer detector so as to inform a user of a replacement time of the developer being consumed for printing jobs. This is because the printing data can be lost during the printing job when the developer is consumed more than a predetermined amount. It is possible to prevent deterioration of a print quality occurring due to a lack of the developer if the residual developer is detected and a user is informed of a replacement time of the developer according to the detected residual developer.

However, the conventional image forming apparatus is implemented to perform the printing jobs unconditionally upon the receipt of the printing data from the external device regardless of the lack of the developer. If the print quality becomes poor due to the lack of the developer, the printing data has to be retransmitted to the image forming apparatus after replacing a developing device. Such a situation causes inconvenience since the user has to retransmit the printing data to the image forming apparatus, and also causes waste of printing papers due to the duplicate printing of the same document.

### SUMMARY OF THE INVENTION

The present general inventive concept provides a method of controlling an image forming apparatus to determine a printing operation depending on a residual developer so as to prevent deterioration of a print quality due to a lack of the residual developer, and waste of printing papers due to a duplicate printing.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of an image forming apparatus having a storage unit to store printing data, the method comprising receiving printing data, detecting a residual developer in a developing device and selectively printing and storing the printing data according to an amount of the detected residual developer.

The method may further comprise setting an auto storage function, wherein the selectively printing and storing of the printing data comprises storing the printing data according to the set auto storage function and the amount of the detected residual developer.

The printing data may be printed when the amount of the detected residual developer is not less than a reference residual developer, and stored the printing data when the amount of the detected residual developer is less than a reference residual developer.

The method may further comprise detecting one of replacement and refill of the developing device; and printing the stored printing data according to the detected one of the replacement and refill of the developing device.

The method may further comprise detecting one of replacement and refill of the developing device; and searching the stored printing data from the storage and printing the searched printing data according to the detected one of the replacement and refill of the developing device.

The method may further comprise generating a message corresponding to a state of a printing operation when the printing data is stored according to the amount of the detected residual developer.

The message may be displayed the generated message.

The generating of the message may be printed information about the generated message.

The storing of the printing data may be prevented the printing data from being printed according to the amount of the detected residual developer.

The foregoing and/or other aspects and advantages of the present general inventive concept may be achieved by providing an image forming apparatus, the method comprising an interface part to receive printing data from an external device, a first storage unit to temporarily store the received printing data, an input part to determine whether an auto storage function is set to store the printing data depending on a residual developer, a residual detector to detect the residual developer in a developing device, a controller to compare the detected residual developer with a predetermined reference residual amount when it is determined that the auto storage function is set and a second storage unit to store the temporarily stored printing data when it is determined that the detected residual developer is less than the reference residual amount.

The first storage unit may be a RAM, and the second storage unit may comprise a non-volatile memory.

The apparatus may further comprise a print engine part to print the printing data stored in the first storage unit and the second storage unit, and to print information of the a message corresponding to a printing operation according to the detected residual developer, wherein the controller controls the print engine part to selectively print the printing data of the first storage unit and the stored printing data of the second storage unit according to the detected residual developer.

The apparatus may further comprise a display to display a printing operation corresponding to the stored printing data of the second storage unit and the detected residual developer of the residual detector.

The residual detector may detect one of refill and replacement of the developing device as the detected residual developer.

The second storage unit may store a file name indicating the stored printing data.

The controller may generate the file name and a printing operation of the printing data according to the detected residual developer, so that information about the file name and the printing operation is displayed or printed.

The foregoing and/or other aspects and advantages of the present general inventive concept may be achieved by providing a method of an image forming apparatus, the method comprising an interface unit to receive printing data, a residual detector to detect a residual developer in a developing device, a memory to store the printing data and a controller to store the printing data according to the detected residual developer.

The controller may print the printing data according to a first state of the detected residual developer and stores the printing data in the memory without printing the printing data according to a second state of the detected residual developer.

The controller may generate a file name indicating the stored printing data of the memory.

### BRIEF DESCRIPTION OF THE DRAWINGS

These and/or other aspects and advantages of the general inventive concept will become apparent and more readily appreciated from the following description of exemplary embodiments, taken in conjunction with the accompanying drawing figures of which:

FIG. 1 is a block diagram of an inkjet printer to determine a printing operation depending on a residual ink according to an embodiment of the present general inventive concept; and

FIG. 2 is a flowchart of a method of controlling an operation of the inkjet printer of FIG. 1.

### DETAILED DESCRIPTION OF THE PREFERRED EMBODIMENTS

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

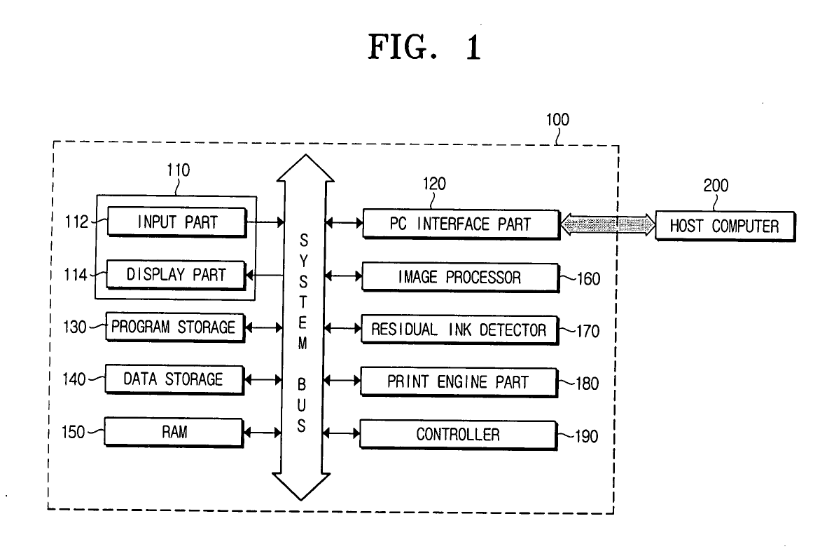

FIG. 1 is a block diagram of an image forming apparatus, such as an inkjet printer 100, to determine a printing operation depending on a residual developer, such as, ink or toner, according to an embodiment of the present general inventive concept. 100, to determine a printing operation depending on a residual developer, such as, ink or toner, according to an embodiment of the present general inventive concept.

Referring to FIG. 1, the inkjet printer 100 includes an operation panel 110, a PC interface part 120, a program storage 130, a data storage 140, a random access memory (RAM) 150, an image processor 160, a residual ink detector 170, a print engine part 180, and a controller 190.

The operation panel 110 includes an input part 112 and a display part 114.

The input part 112 is provided with a plurality of keys to select and set functions supported by the inkjet printer 110. The input part 112 provides the controller 190 with a key input signal according to a key manipulation.

The display part 114 displays an operation state of the inkjet printer 100 under the control of the controller 190, and may employ a liquid crystal display (LCD).

The PC interface part 120 may be connectable to a host computer 200, which is an external device, and may provide a bidirectional communication interface to communicate with the host computer 200. The PC interface part 120 receives printing data from the host computer 200, and sends information relating to a power supply state and a printing job state of the inkjet printer 100 to the host computer 200. The PC interface part 120 may employ IEEE 1284, USB, RS-232C interface modules or network interface modules.

The program storage 130 may store control programs and emulation programs required to implement functions supported by the inkjet printer 100. The emulation programs may include Printer Control Language (PCL), KSM, PostScript (PS), or Epson.

The data storage 140 stores the printing data transmitted from the host computer 200 via the PC interface part 120. The data storage 140 stores data to be stored and data to be printed after an ink cartridge is replaced due to a lack of the residual ink, among the printing data transmitted from the host computer 200. The storage of the printing data in the data storage 140 due to the lack of the residual ink corresponds to a case when an auto storage function is set in the inkjet printer 100. The auto storage function can be set using a certain function key provided to the input part 112 or a driver program (not shown) installed in the host computer 200.

The RAM 150 stores data generated during the operation of the inkjet printer 100. The RAM 150 may store information indicating the setting of the auto storage function. For example, the RAM 150 stores a flag set to ‘0’ or ‘1’ as the information indicating the set of the auto storage function. If the user sets the auto storage function, the flag is set to ‘1,’ and if the user does not set the auto storage function, the flag is set to ‘0.’ The RAM 150 may be a nonvolatile RAM (NVRAM).

The image processor 160 performs rendering and half-toning with respect to the data to be printed using the emulation program stored in the program storage 130, and thus converts the data into bitmap data (0 or 1) recognizable by the print engine part 180. It is noted that the conversion can be omitted if the print data received from the host computer 200 via the PC interface part 120 is the bitmap data.

The residual ink detector 170 detects the residual ink in the ink cartridge (not shown) under the control of the controller 190 and provides the detected residual ink to the controller 190. The residual ink may be detected by measuring a weight of the ink cartridge, using an optical sensor and the like, and various detections method can be applied.

The print engine part 180 performs a printing job with respect to the bitmap data, which is converted by the image processor 160, under the control of the controller 190.

The controller 190 controls an overall operation of the inkjet printer 100 according to the control programs stored in the program storage 130. For example, when the printing data is received through the PC interface 120, the controller 190 determines whether the auto storage function is set by reading the information stored in the RAM 150. The received printing data is temporarily stored in the RAM 150.

If it is determined that the auto storage function of the inkjet printer 100 is set, the controller 190 controls the residual ink detector 170 to detect the residual ink in the ink cartridge so as to obtain a current residual ink.

It is determined whether the received printing data is printed by comparing the detected residual ink and a predetermined reference residual amount. The reference residual amount may be an amount of the ink (developer) set by a user to determine a printing operation, or an amount of the ink required to print the printing data. When the current residual ink in the ink cartridge is greater than the reference residual amount, the controller 190 controls the print engine part 180 to perform the printing job.

When it is determined that the current residual ink in the ink cartridge is less than the reference residual amount, the controller 190 processes to store the received printing data in the data storage 140. At this case, the printing job is not performed until the ink cartridge is replaced with a new one or the ink cartridge is refilled with a new ink.

If the printing data is stored in the data storage 140, the controller 190 generates a guide message indicating that the printing data cannot be printed due to the lack of the residual ink. The generated guide message contains an alarm message indicating the printing data cannot be printed due to the lack of the residual ink, path information relating to a storage location of the printing data, and a file name. The controller 190 processes to display the generated guide message on the display part 114 or a display device (not shown) of the host computer 200 being connected through the PC interface part 120. The controller 190 may control the print engine part 180 to print the guide message.

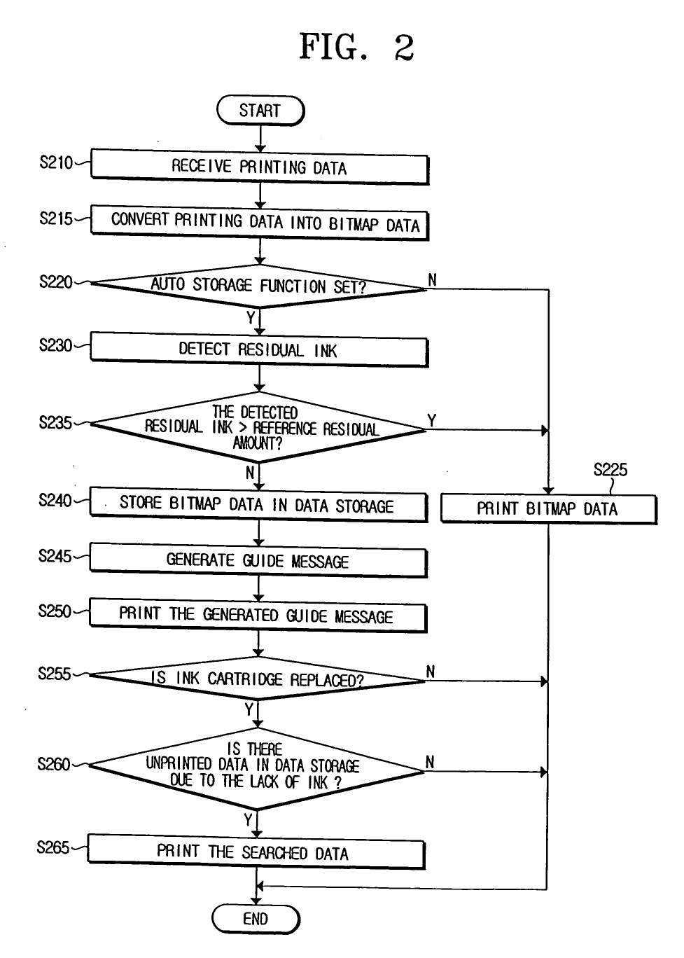

FIG. 2 is a flowchart of a method of controlling the printing operation of the image forming apparatus (inkjet printer 100) of FIG. 1. Referring to FIGS. 1 and 2, the method includes controlling the inkjet printer 100 to determine the printing operation depending on the residual ink.

When the printing data is received from the host computer 200 through the PC interface part 120 (S210), the controller 190 controls the image processor 160 to convert the received printing data into the bitmap data recognizable by the print engine part 180 (S215). The converted bitmap data is temporarily stored in the RAM 150.

The controller 190 determines whether the auto storage function of the inkjet printer 100 is set (S220). Specifically, the controller 190 determines the set of the auto storage function by reading the flag in the RAM 150. If the flag is set to ‘1,’ the controller 190 determines that the auto storage function is set, and if the flag is set to ‘0,’ the controller 190 determines that the auto storage function is not set.

If it is determined that the auto storage function of the inkjet printer 100 is not set (S220), the controller 190 controls the print engine part 180 to print the bitmap data being temporarily stored in the RAM 150 (S225). The print engine part 180 prints the bitmap data under the control of the controller 190.

If it is determined that the auto storage function of the inkjet printer 100 is set (S220), the controller 190 controls the residual ink detector 170 to detect the residual ink in the ink cartridge (S230). The residual ink detector 170 detects the ink remaining in the ink cartridge under the control of the controller 190 and provides the detected residual ink to the controller 190.

The controller 190 determines whether the detected residual ink is greater than the reference residual amount by comparing the detected residual ink and the predetermined reference residual amount (S235). If the detected residual ink is greater than the reference residual amount, the controller 190 performs the printing job (S225).

If the detected residual ink is not greater than the reference residual amount, the controller 190 processes to store the bitmap data, which is temporarily stored in the RAM 150, in the data storage 140 (S240).

The controller 190 generates the guide message indicating the infeasibility of the current printing job due to the lack of the residual ink (S245). The controller 190 processes to display the generated guide message on the display device of the display part 114 or to generate a signal corresponding to the guide message to the host computer 200, and controls the print engine part 180 to print the guide message (S250). The user can perceive the lack of the developer, the file name of the printing data stored in the data storage 140, and the storage path according to the guide message.

The controller 190 determines that the ink cartridge is replaced (S255). The replacement of the ink cartridge can be determined using information relating to the residual ink detected by the residual ink detector 170, and using a separate determination circuit to recognize the replacement of the ink cartridge, but not limited to these. It should be appreciated that the replacement of the ink cartridge may be confirmed using various methods.

If it is confirmed that the ink cartridge in the inkjet printer 100 is replaced (S255), the controller 190 searches any data in the data storage 140, which is not printed due to the lack of the ink (S260).

If any data, which is not printed due to the lack of the ink, is searched from the data storage 140, the controller 190 displays on the display device of the display part 114 or the host computer 200 a message indicating the presence of the data in the data storage 140 being not printed due to the lack of the developer. The controller 190 controls the print engine part 180 to print the searched data (S265).

In the above description, it is implemented to automatically print the unprinted data in the data storage 140 in correspondence with the replacement of the ink cartridge, but not limited to this example. The unprinted data may be printed selectively depending on the user's selection.

The inkjet printer 100 utilizing the ink as the developer is illustrated but not limited thereto. It is possible to employ a beam printer using toner as the developer as the image forming apparatus.

As described above, the method of controlling the image forming apparatus to determine the printing operation depending on the residual ink according to an embodiment of the present general inventive concept, can prevent poor quality of printouts due to the lack of the developer, and waste of printing papers.

Since the printing data is stored in the storage in a case of the lack of the developer, the user needs not to retransmit the printing data, and then the print speed is not lowered as compared with a conventional arrangement of a conventional image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of an image forming apparatus having a storage unit to store printing data, the method comprising:
receiving printing data;
detecting a residual developer in a developing device; and
selectively printing and storing the printing data according to an amount of the detected residual developer.

2. The method of claim 1, further comprising:
setting an auto storage function,
wherein the selectively printing and storing of the printing data comprises storing the printing data according to the set auto storage function and the amount of the detected residual developer.

3. The method of claim 1, wherein the selectively printing and storing the printing data comprises printing the printing data when the amount of the detected residual developer is not less than a reference residual developer, and storing the printing data when the amount of the detected residual developer is less than a reference residual developer.

4. The method of claim 1, further comprising:
detecting one of replacement and refill of the developing device; and
printing the stored printing data according to the detected one of the replacement and refill of the developing device.

5. The method of claim 1, further comprising:
detecting one of replacement and refill of the developing device; and
searching the stored printing data from the storage and printing the searched printing data according to the detected one of the replacement and refill of the developing device.

6. The method of claim 1, further comprising
generating a message corresponding to a state of a printing operation when the printing data is stored according to the amount of the detected residual developer.

7. The method of claim 6, wherein the generating of the message comprises displaying the generated message.

8. The method of claim 6, wherein the generating of the message comprises printing information about the generated message.

9. The method of claim 1, wherein the storing of the printing data comprises preventing the printing data from being printed according to the amount of the detected residual developer.

10. An image forming apparatus, the method comprising:
an interface part to receive printing data from an external device;
a first storage unit to temporarily store the received printing data;
an input part to determine whether an auto storage function is set to store the printing data depending on a residual developer;
a residual detector to detect the residual developer in a developing device;
a controller to compare the detected residual developer with a predetermined reference residual amount when it is determined that the auto storage function is set; and
a second storage unit to store the temporarily stored printing data when it is determined that the detected residual developer is less than the reference residual amount.

11. The apparatus of claim 10, wherein the first storage unit is a RAM, and the second storage unit comprises a non-volatile memory.

12. The apparatus of claim 10, further comprising:
a print engine part to print the printing data stored in the first storage unit and the second storage unit, and to print information of the a message corresponding to a printing operation according to the detected residual developer,
wherein the controller controls the print engine part to selectively print the printing data of the first storage unit and the stored printing data of the second storage unit according to the detected residual developer.

13. The apparatus of claim 10, further comprising:
a display to display a printing operation corresponding to the stored printing data of the second storage unit and the detected residual developer of the residual detector.

14. The apparatus of claim 10, wherein the residual detector detects one of refill and replacement of the developing device as the detected residual developer.

15. The apparatus of claim 10, wherein the second storage unit stores a file name indicating the stored printing data.

16. The apparatus of claim 10, wherein the controller generates the file name and a printing operation of the printing data according to the detected residual developer, so that information about the file name and the printing operation is displayed or printed.

17. An image forming apparatus, the method comprising:
an interface unit to receive printing data;
a residual detector to detect a residual developer in a developing device;
a memory to store the printing data; and
a controller to store the printing data according to the detected residual developer.

18. The apparatus of claim 17, wherein the controller prints the printing data according to a first state of the detected residual developer and stores the printing data in the memory without printing the printing data according to a second state of the detected residual developer.

19. The apparatus of claim 17, wherein the controller generates a file name indicating the stored printing data of the memory.
